(19) United States
(12) Patent Application Publication
(10) Pub. No.: US 2016/0366621 A1
(43) Pub. Date: Dec. 15, 2016

(54) HANDLING MOBILITY EVENTS IN A MULTI SUBSCRIBER IDENTITY MODULE MULTI STANDBY MOBILE COMMUNICATION DEVICE

(71) Applicant: QUALCOMM Incorporated, San Diego, CA (US)

(72) Inventors: Karthikeyan Sabapathi, Hyderabad (IN); Praveen Peruru, Hyderabad (IN); Narendra Pulicherla, Hyderabad (IN); Ramesh Pantham, Hyderabad (IN)

(21) Appl. No.: 14/737,256

(22) Filed: Jun. 11, 2015

(51) Int. Cl. H04W 36/00; H04W 8/18

(52) U.S. Cl. CPC H04W 36/0083; H04W 8/183; H04W 36/36

(57) ABSTRACT

A method for managing reselection that includes: determining that a first subscription and a second subscription are in an idle state; determining whether a signal quality (S_{qual}) of a serving cell on the first subscription exceeds a threshold; and in response to determining that the signal quality (S_{qual}) of the serving cell on the first subscription does not exceed the threshold, reselecting to a neighbor cell on the first subscription and on the second subscription.

### BACKGROUND

In a multi-subscriber identity module (SIM) multi-standby (MSMS) mobile communication device, at least two subscriptions may be associated with the same mobile service provider (MSP). As such, the MSMS mobile communication device may be connected to and/or camped on a serving cell with poor radio frequency (RF) channel conditions (e.g., low signal quality (S_{qual})) on multiple subscriptions.

In a conventional MSMS mobile communication device, mobility events (e.g., reselection, handover) on one subscription are independent of mobility events on other subscriptions. Thus, even after a conventional MSMS mobile communication device moves (e.g., reselects, hands over) to a neighbor cell with better RF channel conditions on one subscription, the conventional MSMS mobile communication device may still remain camped on the original serving cell with poor RF channel conditions on one or more other subscriptions.

As a result, a conventional MSMS mobile communication device may miss paging messages on subscriptions in an idle state that remain camped on the original serving cell. Additionally, a conventional MSMS mobile communication device may experience degraded voice call quality or data call throughput on subscriptions that remain camped on the original serving cell.

### SUMMARY

Apparatuses and methods for handling mobility events in a MSMS mobile communication device are provided.

According to the various embodiments, there is provided a method for managing reselection. The method may include: determining that a first subscription and a second subscription are in an idle state; determining whether a signal quality (S_{qual}) of a serving cell on the first subscription exceeds a threshold; and in response to determining that the signal quality (S_{qual}) of the serving cell on the first subscription does not exceed the threshold, reselecting to a neighbor cell on the first subscription and on the second subscription.

According to the various embodiments, there is provided a method for handling mobility events. The method may include: determining that a first subscription is in an idle state and a second subscription is in a connected state; determining whether a handover from a serving cell to a neighbor cell was successfully performed on the second subscription; and in response to determining that the handover from the serving cell to the neighbor cell was successfully performed on the second subscription: initiating a reselection on the first subscription; and reselecting to the same neighbor cell on the first subscription.

According to the various embodiments, there is provided a mobile communication device. In some embodiments, the mobile communication device may include a control unit and an RF chain.

The control unit may be configured to: determine that a first subscription and a second subscription are in an idle state; determine whether a signal quality (S_{qual}) of a serving cell on the first subscription exceeds a threshold; and in response to determining that the signal quality (S_{qual}) of the serving cell on the first subscription a does not exceed the threshold, reselect to neighbor cell on the first subscription and on the second subscription.

According to various embodiments, there is provided a mobile communication device. In some embodiments, the mobile communication device may include a control unit and an RF chain.

The control unit may be configured to: determine that a first subscription is in an idle state and a second subscription is in a connected state; determine whether a handover from a serving cell to a neighbor cell was successfully performed on the second subscription; and in response to determining that the handover from the serving cell to the neighbor cell was successfully performed on the second subscription: initiate a reselection on the first subscription; and reselect to the same neighbor cell on the first subscription.

Other features and advantages of the present inventive concept should be apparent from the following description which illustrates by way of example aspects of the present inventive concept.

### BRIEF DESCRIPTION OF THE DRAWINGS

Aspects and features of the present inventive concept will be more apparent by describing example embodiments with reference to the accompanying drawings, in which:

FIG. 1 is a system diagram illustrating a network environment for various embodiments;

FIG. 2 is a block diagram illustrating a mobile communication device according to various embodiments;

FIG. 3 is a flowchart illustrating a process for handling mobility events according to various embodiments;

FIG. 4 is a flowchart illustrating a process for handling mobility events according to various embodiments; and

FIG. 5 is a flowchart illustrating a process for handling mobility events according to various embodiments.

### DETAILED DESCRIPTION

While a number of embodiments are described herein, these embodiments are presented by way of example only, and are not intended to limit the scope of protection. The apparatuses and methods described herein may be embodied in a variety of other forms. Furthermore, various omissions, substitutions, and changes in the form of the example apparatuses and methods described herein may be made without departing from the scope of protection.

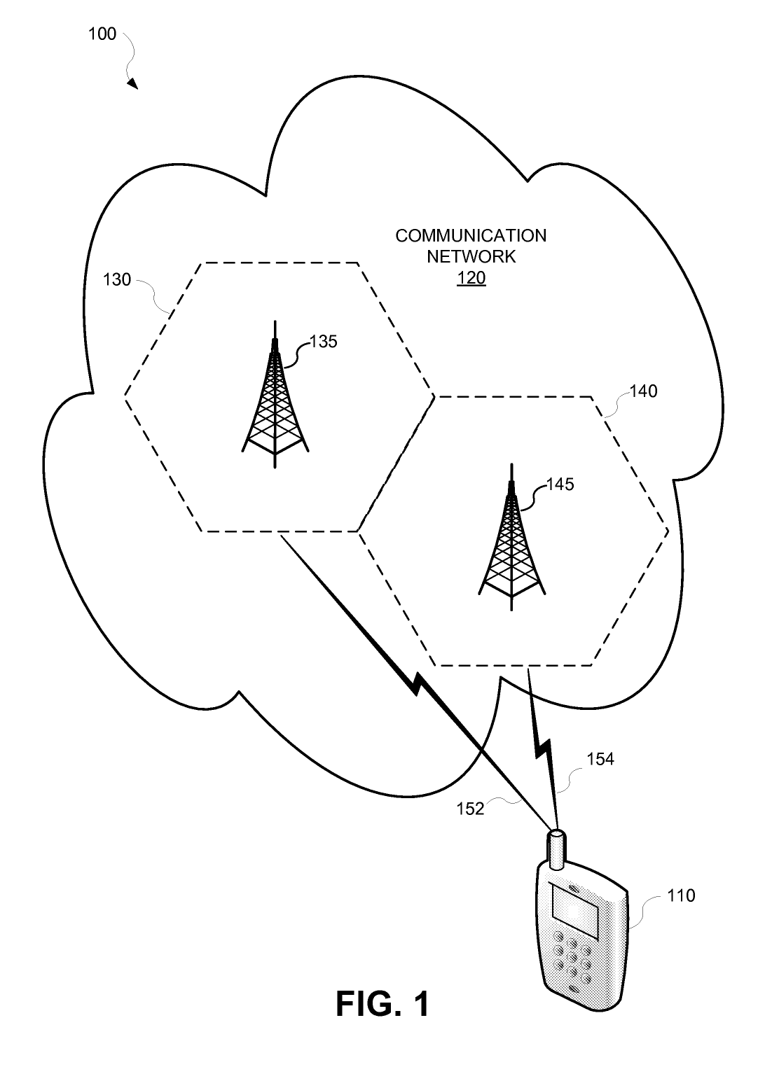

FIG. 1 is a system diagram illustrating a network environment 100 for various embodiments. Referring to FIG. 1, a communication network 120 may include a first cell 130 and a second cell 140. The first cell 130 may be associated with a first base transceiver station (BTS) 135, and the second cell 140 may be associated with a second BTS 145. In various embodiments, the communication network 120 may be, for example, but not limited to, a wireless or mobile communication network.

Although the communication network 120 is shown to include the first cell 130 and the second cell 140, the communication network 120 may include a different number of cells and corresponding BTSs without departing from the scope of the present inventive concept. Furthermore, a person having ordinary skill in the art can appreciate that the network environment 100 may include more than one communication network and/or more than one mobile communication device without departing from the scope of the present inventive concept.

The mobile communication device 110 may communicate with the communication network 120 on a first subscription 152 and on a second subscription 154. For example, the mobile communication device 110 may be in an idle state on the first subscription 152. Meanwhile, the mobile communication device 110 may be in an idle state or in a connected state (e.g., engaged in a voice call or a data call) on the second subscription 154.

The mobile communication device 110 may communicate with the communication network 120 on the first subscription 152 via the first BTS 135 of the first cell 130. In addition, the mobile communication device 110 may communicate with the communication network 120 on the second subscription 154 via the first BTS 135 of the first cell 130. Alternately, the mobile communication device 110 may communicate with the communication network 120 on the second subscription 154 via the second BTS 145 of the second cell 140.

A person having ordinary skill in the art can appreciate that the mobile communication device 110 may communicate with the communication network 120 on the first subscription 152 and the second subscription 154 via the same cell or different cells without departing from the scope of the present inventive concept.

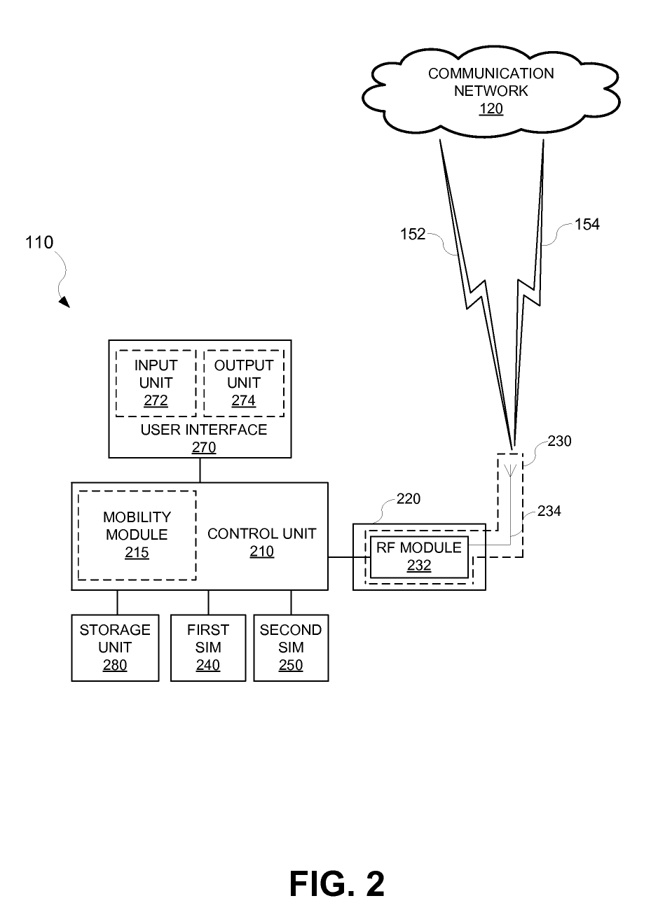

FIG. 2 is a block diagram illustrating a mobile communication device 110 according to various embodiments. Referring to FIGS. 1 and 2, in various embodiments, the mobile communication device 110 may include a control unit 210, a communication unit 220, a first SIM 240, a second SIM 250, a user interface 270, and a storage unit 280.

In various embodiments, the mobile communication device 110 may be any device capable of wirelessly communicating with one or more communication networks. In various embodiments, the mobile communication device 110 may be, for example, but not limited to, a smartphone, a tablet PC, or a laptop computer.

A SIM (for example the first SIM 240 and/or the second SIM 250) in various embodiments may be a Universal Integrated Circuit Card (UICC) that is configured with SIM and/or USIM applications, enabling access to GSM and/or UMTS networks. The UICC may also provide storage for a phone book and other applications. Alternatively, in a CDMA network, a SIM may be a UICC removable user identity module (R-UIM) or a CDMA subscriber identity module (CSIM) on a card. A SIM card may have a CPU, ROM, RAM, EEPROM and I/O circuits. An Integrated Circuit Card Identity (ICCID) SIM serial number may be printed on the SIM card for identification. However, a SIM may be implemented within a portion of memory of the mobile communication device 110, and thus need not be a separate or removable circuit, chip, or card.

A SIM used in various embodiments may store user account information, an IMSI, a set of SIM application toolkit (SAT) commands, and other network provisioning information, as well as provide storage space for phone book database of the user's contacts. As part of the network provisioning information, a SIM may store home identifiers (e.g., a System Identification Number (SID)/Network Identification Number (NID) pair, a Home PLMN (HPLMN) code, etc.) to indicate the SIM card network operator provider.

In various embodiments, the communication unit 220 may include an RF chain 230. The RF chain 230 may include, for example, but not limited to, an RF module 232 and an antenna 234. Although the mobile communication device 110 is shown to include a single communication unit (e.g., the communication unit 220), a person having ordinary skill in the art can appreciate that the mobile communication device 110 may include additional communication units without departing from the scope of the present inventive concept.

In various embodiments, the first SIM 240 may associate the communication unit 220 with the first subscription 152 on the communication network 120 while the second SIM 250 may associate the communication unit 220 with the second subscription 154 on the communication network 120.

In various embodiments, the communication network 120 may support one or more radio access technologies (RATs), including, for example, but not limited to Wideband Code Division Multiple Access (WCDMA), Global System for Mobile communications (GSM), Long Term Evolution (LTE), and Time Division-Synchronous Code Division Multiple Access (TD-SCDMA).

In various embodiments, the user interface 270 may include an input unit 272. In some embodiments, the input unit 272 may be, for example, but not limited to, a keyboard or a touch panel. In various embodiments, the user interface 270 may include an output unit 274. In some embodiments, the output unit 274 may be, for example, but not limited to, a liquid crystal display (LCD) or a light emitting diode (LED) display. A person having ordinary skill in the art will appreciate that other types or forms of input and output units may be used without departing from the scope of the present inventive concept.

In various embodiments, the control unit 210 may be configured to control the overall operation of the mobile communication device 110 including controlling the functions of the communication unit 220. In various embodiments, the control unit 210 may include a mobility module 215 configured to handle one or more mobility events on the first subscription 152 and/or the second subscription 154. In various embodiments, the control unit 210 may be, for example, but not limited to, a microprocessor (e.g., general-purpose processor, baseband modem processor, etc.) or a microcontroller.

In various embodiments, the storage unit 280 may be configured to store application programs, application data, and user data. In various embodiments, at least some of the application programs stored at the storage unit 280 may be executed by the control unit 210 for the operation of the mobile communication device 110.

In various embodiments, the control unit 210 may be configured to trigger a mobility event (e.g., reselection, handover, etc.) on one of the first subscription 152 and the second subscription 154 in response to a mobility event on the other of the first subscription 152 and the second subscription 154.

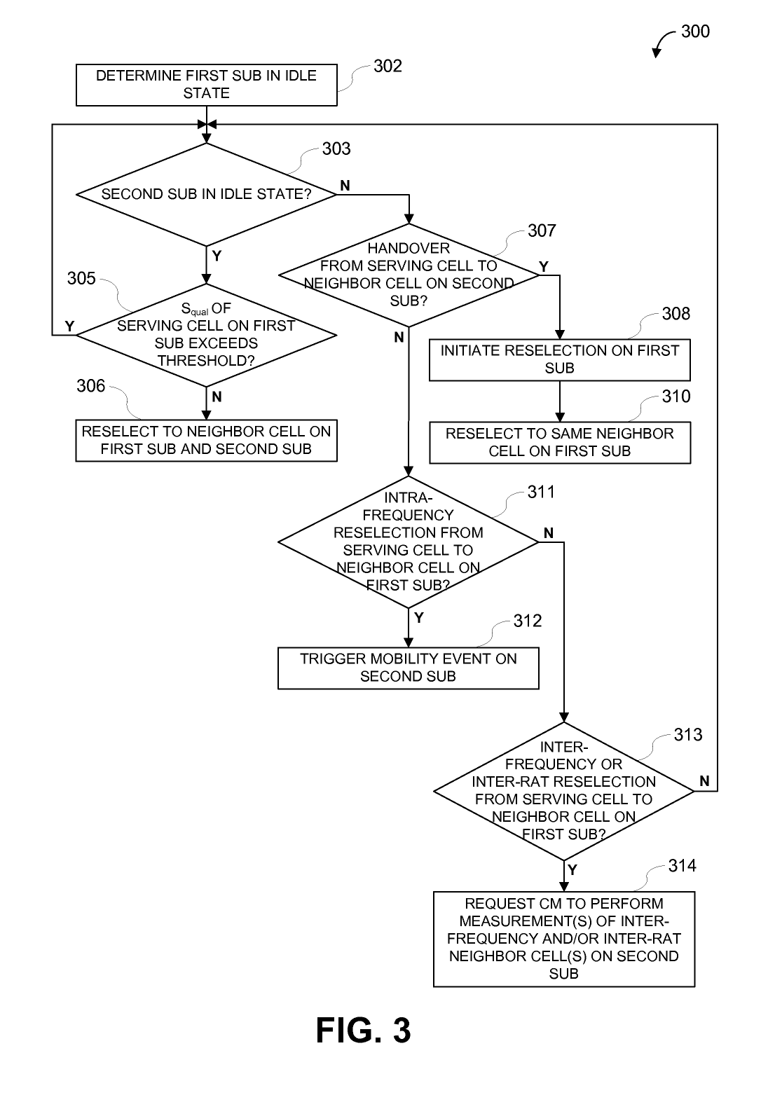

FIG. 3 is a flowchart illustrating a process 300 for handling mobility events according to various embodiments. With references to FIGS. 1-3, in various embodiments, the process 300 may be performed by the control unit 210, for example, by the mobility module 215.

The control unit 210 may determine that the mobile communication device 110 is in an idle state on the first subscription 152 (302). For example, the mobile communication device 110 may be camped on the first cell 130 of the communication network 120 on the first subscription 152.

While the mobile communication device 110 is in an idle state on the first subscription 152, the mobile communication device 110 may be in an idle state or a connected state on the second subscription 154. As such, the control unit 210 may determine whether the mobile communication device 110 is in an idle state on the second subscription 154 (303).

The control unit 210 may determine that the mobile communication device 110 is in an idle state on the second subscription 154 (303-Y). For example, the mobile communication device 110 may be camped on the first cell 130 (or a different cell) of the communication network 120 on the second subscription 154. As such, the control unit 210 may determine whether a signal quality (S_{qual}) of a serving cell on the example, first subscription 152 exceeds a threshold (305). For example, the control unit 210 may determine a ratio of energy per chip relative to noise spectral density (Ec/No) of a signal on the common pilot channel (CPICH) from the first cell 130 of the communication network 120.

If the control unit 210 determines that the signal quality (S_{qual}) of the serving cell on the first subscription 152 does not exceed the threshold (305-N), the control unit 210 may reselect to a neighbor cell on the first subscription 152 and on the second subscription 154 (306). The serving cell and the neighbor cell may both be associated with a same public land mobile network (PLMN). For example, the control unit 210 may measure on the first subscription 152 the signal quality (S_{qual}) of the first cell 130 of the communication network 120. The control unit 210 may determine that the Ec/No of the signal from the first cell 130 does not exceed a threshold. As such, the control unit 210 may trigger a reselection to the second cell 140 of the communication network 120 on both the first subscription 152 and the second subscription 154.

Alternately, the control unit 210 may determine that the signal quality (S_{qual}) of the serving cell does exceed the threshold (305-Y). For example, the control unit 210 may determine that the signal quality (S_{qual}) of the first cell 130 is sufficient for the mobile communication device 110 to remain camped on the first cell 130 of the communication network 120 on both the first subscription 152 and the second subscription 154. As such, the control unit 210 may continue to monitor for changes in the state of the mobile communication device 110 on the second subscription 154 at operation 303.

The control unit 210 may determine that the mobile communication device 110 is not in an idle state on the second subscription 154 (303-N). For example, the mobile communication device 110 may be in a connected state (e.g., engaged in a voice call or a data call) on the second subscription 154. As such, the control unit 210 may determine whether a handover from a serving cell to a neighbor cell was successfully performed on the second subscription 154 (307).

The control unit 210 may determine that a handover from a serving cell to a neighbor cell was successfully performed on the second subscription 154 (307-Y). For example, the mobile communication device 110 may initially be engaged in a voice call or a data call on the second subscription 154 via the first cell 130 of the communication network 120. In response to detecting a low signal quality (S_{qual}) from the first cell 130, a handover may be performed from the first cell 130 to the second cell 140 of the communication network 120. As such, the mobile communication device 110 may continue to engage in the voice call or data call on the second subscription 154 via the second cell 140 of the communication network 120.

In response to determining that a handover from a serving cell to a neighbor cell was successfully performed on the second subscription 154, the control unit 210 may initiate a reselection on the first subscription 152 (308). For example, in response to determining that a handover to the second cell 140 of the communication network 120 was successfully performed on the second subscription 154, the control unit 210 may initiate a reselection on the first subscription 152.

The control unit 210 may reselect to the same neighbor cell on the first subscription 152 (310). For example, the control unit 210 may also reselect to the second cell 140 on the first subscription 152. As a result, the mobile communication device 110 may be camped on the second cell 140 of the communication network 120 on the first subscription 152.

Alternately, the control unit 210 may determine that a handover from a serving cell to a neighbor cell was not successfully performed on the second subscription 154 (307-N). In response, the control unit 210 may determine whether an intra-frequency reselection from a serving cell to a neighbor cell was successfully performed on the first subscription 152 (311).

The control unit 210 may determine that an intra-frequency reselection from a serving cell to a neighbor cell was successfully performed on the first subscription 152 (311-Y). For example, the mobile communication device 110 may be initially camped on the first cell 130 of the communication network 120 on the first subscription 152. However, in response to detecting a low signal quality (S_{qual}) from the first cell 130, the mobile communication device 110 may reselect on the first subscription 152 from the first cell 130 to the second cell 140 of the communication network 120, which may be on the same carrier frequency as the first cell 130. The control unit 210 may trigger a mobility event on the second subscription 154 (312).

If the control unit 210 determines that an intra-frequency reselection from a serving cell to a neighbor cell was not successfully performed on the first subscription 152 (311-N), the control unit 210 may determine whether an inter-frequency or inter-RAT reselection from a serving cell to a neighbor cell was successfully performed on the first subscription 152 (313). For example, the mobile communication device 110 may be initially camped on the first cell 130 of the communication network 120 on the first subscription 152. In response to detecting a low signal quality (S_{qual}) from the first cell 130, the mobile communication device 110 may reselect on the first subscription 152 from the first cell 130 to the second cell 140 of the communication network 120. Although the first cell 130 and the second cell 140 may both be associated with the communication network 120, the first cell 130 and the second cell 140 may be on different carrier frequencies and/or implement different RATs.

If the control unit 210 determines that an inter-frequency or inter-RAT reselection from a serving cell to a neighbor cell was successfully performed on the first subscription 152 (313-Y), the control unit 210 may transmit a request for compressed mode (CM) to the communication network 120 in order to perform measurements of at least one inter-frequency or inter-RAT neighbor cells on the second subscription 154 (314). For example, the mobile communication device 110 may utilize the RF chain 230 to engage in a voice call or a data call on the second subscription 154. During CM operation, the mobile communication device 110 may utilize the RF chain 230 to perform measurements of one or more inter-frequency and inter-RAT neighbor cells (e.g., the second cell 140) during transmission gaps placed during the voice call or data call on the second subscription 154.

Alternately, the control unit 210 may determine that an inter-frequency or inter-RAT reselection from a serving cell to a neighbor cell was not successfully performed on the first subscription 152 (313-N). For example, the control unit 210 may determine that a handover or a reselection was not performed on either the first subscription 152 or the second subscription 154 while the mobile communication device 110 is in an idle state on the first subscription 152 and engaged in a voice call or data call on the second subscription 154. Thus, the control unit 210 may continue to monitor for changes in the state of the mobile communication device 110 on the second subscription 154 at operation 303.

Although the first subscription 152 is described as the subscription that is determined to be in an idle state in the process 300, a person having ordinary skill in the art can appreciate that a state of the first subscription 152 and the second subscription 154 in the mobile communication device 110 may be interchangeable without departing from the scope of the present inventive concept.

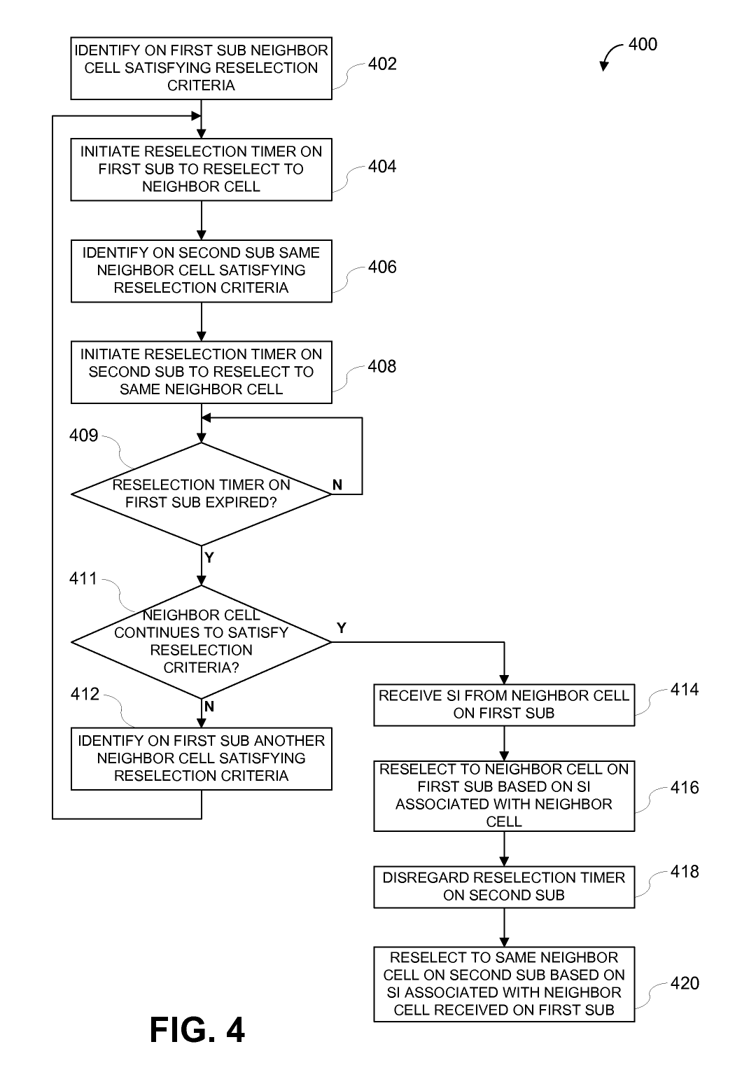

FIG. 4 is a flowchart illustrating a process 400 for handling mobility events according to various embodiments. With references to FIGS. 1-4, in various embodiments, the process 400 may be performed by the control unit 210, for example, by the mobility module 215 and may implement the operation 306 of the process 300.

The control unit 210 may identify on the first subscription 152 a neighbor cell satisfying one or more reselection criteria (402). For example, the control unit 210 may identify the first cell 130 of the communication network 120 based on a signal quality (S_{qual}) (e.g., Ec/No) of one or more neighbor cells including, for example, but not limited to, the first cell 130 and the second cell 140.

The control unit 210 may initiate a reselection timer on the first subscription 152 to reselect to the neighbor cell (404). For example, the control unit 210 may initiate a reselection timer on the first subscription 152 to reselect to the first cell 130 of the communication network 120.

The control unit 210 may identify on the second subscription 154 the same neighbor cell satisfying the one or more reselection criteria (406). For example, based on a signal quality (S_{qual}) (e.g., Ec/No) of one or more neighbor cells, the control unit 210 may identify the first cell 130 of the communication network 120 on the second subscription 154 based on a signal quality (S_{qual}) (e.g., Ec/No) of one or more neighbor cells. The control unit 210 may initiate a reselection timer on the second subscription 154 to reselect to the neighbor cell (408).

The control unit 210 may determine whether the reselection timer on the first subscription 152 is expired (409). The control unit 210 may continuously monitor a status of the reselection timer. Thus, if the control unit 210 determines that the reselection timer on the first subscription 152 is not expired (409-N), the control unit 210 may continue to monitor the reselection timer on the first subscription 152 is expired (409).

In contrast, if the control unit 210 determines that the reselection timer on the first subscription 152 is expired (409-Y), the control unit 210 may determine whether the neighbor cell continues to satisfy the one or more reselection criteria (411). For example, upon expiration of the reselection timer on the first subscription 152, the control unit 210 may determine whether the signal quality (S_{qual}) (e.g., Ec/No) of the first cell 130 of the communication network 120 still satisfies the one or more reselection criteria.

If the control unit 210 determines that the neighbor cell does not continue to satisfy the one or more reselection criteria (411-N), the control unit 210 may identify on the first subscription 152 another neighbor cell satisfying the one or more reselection criteria (412). For example, if the control unit 210 determines that the signal quality (S_{qual}) (e.g., Ec/No) of the first cell 130 no longer satisfies the one or more reselection criteria, the control unit 210 may identify the second cell 140 of the communication network 120 based on the signal quality (S_{qual}) (e.g., Ec/No) of one or more neighbor cells.

The control unit 210 may initiate a reselection timer on the first subscription 152 to reselect to the neighbor cell (404). For example, the control unit 210 may initiate another reselection timer on the first subscription 152 to reselect to the second cell 140 of the communication network 120.

Alternately, if the control unit 210 determines that the neighbor cell continues to satisfy one or more reselection criteria (411-Y), the control unit 210 may receive system information (SI) from the neighbor cell on the first subscription 152 (414). For example, the first BTS 135 of the first cell 130 may broadcast SI for the first cell 130 on a broadcast control channel (BCCH). The control unit 210 may receive SI associated with the first cell 130 on the BCCH.

The control unit 210 may reselect to the neighbor cell on the first subscription 152 based on the SI associated with the neighbor cell (416). For example, based on the SI for the first cell 130 of the communication network 120, the control unit 210 may reselect to the first cell 130 on the first subscription 152. As a result, the mobile communication device 110 may be camped on the first cell 130 of the communication network 120 on the first subscription 152.

The control unit 210 may disregard the reselection timer on the second subscription 154 (418). For example, upon reselecting to the first cell 130 on the first subscription 152, the control unit 210 may disregard the reselection timer even if the reselection timer on the second subscription 154 is not expired.

The control unit 210 may reselect to the same neighbor cell on the second subscription 154 based on the SI associated with the neighbor cell received on the first subscription 152 (420). For example, the control unit 210 may also reselect to the first cell 130 on the second subscription 154. As a result, the mobile communication device 110 may also be camped on the first cell 130 of the communication network 120 on the second subscription 154.

A person having ordinary skill in the art can appreciate that the operations in the process 400 may be performed in a different order without departing from the scope of the present inventive concept. Thus, although the reselection on the first subscription 152 is described as triggering the reselection on the second subscription 154 in the process 400, a person having ordinary skill in the art can appreciate that an order of the reselection on the first subscription 152 and the second subscription 154 in the mobile communication device 110 may be interchangeable without departing from the scope of the present inventive concept.

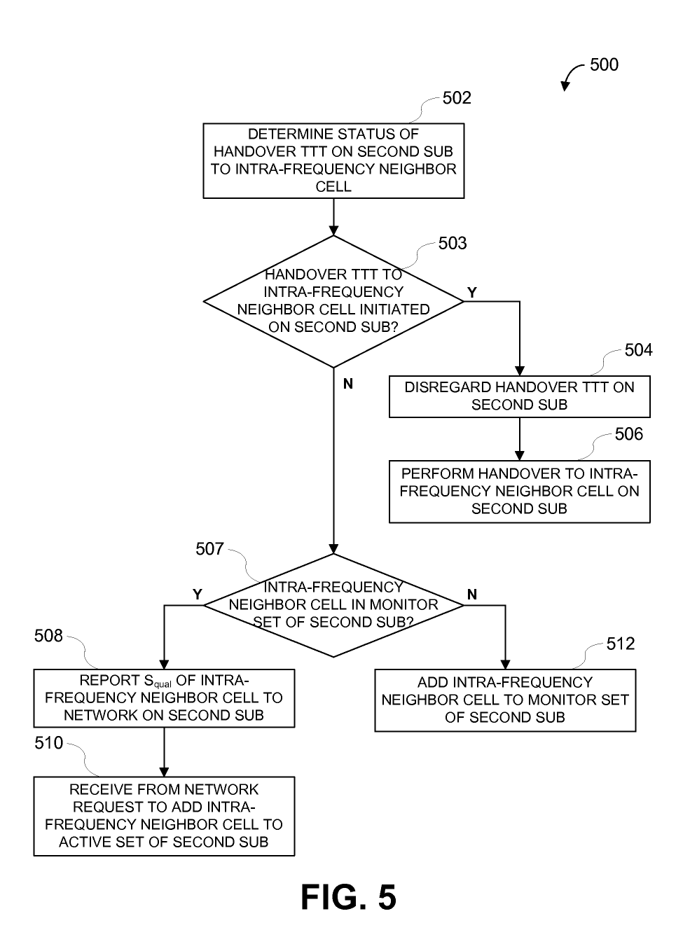

FIG. 5 is a flowchart illustrating a process 500 for handling mobility events according to various embodiments. With references to FIGS. 1-3 and 5, in various embodiments, the process 500 may be performed by the control unit 210, for example, by the mobility module 215 and may implement operation 312 of the process 300.

The control unit 210 may determine a status of a handover time-to-trigger (TTT) to an intra-frequency neighbor cell on the second subscription 154 (502). The control unit 210 may determine whether the handover TTT to the intra-frequency neighbor cell is initiated on the second subscription 154 (503). In response to determining that the handover TTT to the intra-frequency neighbor cell is initiated on the second subscription 154 (503-Y), the control unit 210 may disregard the handover TTT (504). For example, upon a successful intra-frequency reselection to the first cell 130 of the communication network 120 on the first subscription 152, the control unit 210 may disregard the handover TTT on the second subscription 154 even if the TTT is not expired.

The control unit 210 may perform a handover on the second subscription 154 to the intra-frequency neighbor cell (506). For example, the mobile communication device 110 may be engaged in a voice call or a data call on the second subscription 154 via the second cell 140 of the communication network 120. Upon a successful intra-frequency reselection to the first cell 130 of the communication network 120 on the first subscription 152, the control unit 210 may perform a handover from the second cell 140 to the first cell 130 on the second subscription 154. Accordingly, the mobile communication device 110 may continue to engage in the voice call or data call on the second subscription 154 via the first cell 130 of the communication network 120.

Alternately, the control unit 210 may determine that a handover TTT is not initiated on the second subscription 154 (503-N). As such, the control unit 210 may determine whether the intra-frequency neighbor cell is in a monitor set of the second subscription 154 (507).

If the control unit 210 determines that the intra-frequency neighbor cell is in the monitor set of the second subscription 154 (507-Y), the control unit 210 may report the signal quality (S_{qual}) the intra-frequency neighbor cell to the communication network 120 on the second subscription 154 (508). For example, if the control unit 210 determines that the first cell 130 of the communication network 120 is already in the monitor set of the second subscription 154, the control unit 210 may transmit a measurement report that includes the signal quality (S_{qual}) of the first cell 130 to the communication network 120 on the second subscription 154.

The control unit 210 may receive from the communication network 120 a request to add the intra-frequency neighbor cell to an active set of the second subscription 154 (510). For example, in response to the measurement report, the communication network 120 may transmit an active set update message to the mobile communication device 110. An active set of the second subscription 154 may include one or more cells that the mobile communication device 110 may be connected to on the second subscription 154. The active set update message may include instructions from the communication network 120 to add the first cell 130 to an active set of the second subscription 154.

Alternately, if the control unit 210 determines that the intra-frequency neighbor cell is not in the monitor set of the second subscription 154 (507-N), the control unit 210 may add the intra-frequency neighbor cell to the monitor set of the second subscription 154 (512). The monitor set of the second subscription 154 may include one or more cells that the mobile communication device 110 may have detected on the second subscription 154. The mobile communication device 110 may perform one or more measurements (e.g., inter-frequency, intra-frequency, and/or inter-RAT) on the second subscription 154 of the one or more cells included in the monitor set. Thus, the control unit 210 may add the first cell 130 of the communication network 120 to the monitor set of the second subscription 154 in response to determining that the first cell 130 is not in the monitor set of the second subscription 154.

Although the process 500 is described with respect to the second subscription 154, a person having ordinary skill in the art can appreciate that the process 500 may also be performed with respect to the first subscription 152 without departing from the scope of the present inventive concept.

The accompanying claims and their equivalents are intended to cover such forms or modifications as would fall within the scope and spirit of the protection. For example, the example apparatuses, methods, and systems disclosed herein may be applied to multi-SIM wireless devices subscribing to multiple communication networks and/or communication technologies. The various components illustrated in the figures may be implemented as, for example, but not limited to, software and/or firmware on a processor, ASIC/FPGA/DSP, or dedicated hardware. Also, the features and attributes of the specific example embodiments disclosed above may be combined in different ways to form additional embodiments, all of which fall within the scope of the present disclosure.

The foregoing method descriptions and the process flow diagrams are provided merely as illustrative examples and are not intended to require or imply that the operations of the various embodiments must be performed in the order presented. As will be appreciated by one of skill in the art the order of operations in the foregoing embodiments may be performed in any order. Words such as “thereafter,” “then,” “next,” etc., are not intended to limit the order of the operations; these words are simply used to guide the reader through the description of the methods. Further, any reference to claim elements in the singular, for example, using the articles “a,” “an,” or “the” is not to be construed as limiting the element to the singular.

The various illustrative logical blocks, modules, circuits, and operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present inventive concept.

The hardware used to implement the various illustrative logics, logical blocks, modules, and circuits described in connection with the various embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more exemplary embodiments, the functions described may be implemented in hardware, software, firmware, or any combination thereof. If implemented in software, the functions may be stored as one or more instructions or code on a non-transitory computer-readable storage medium or non-transitory processor-readable storage medium. The operations of a method or algorithm disclosed herein may be embodied in processor-executable instructions that may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include random access memory (RAM), read-only memory (ROM), electrically erasable programmable read-only memory (EEPROM), FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

Although the present disclosure provides certain example embodiments and applications, other embodiments that are apparent to those of ordinary skill in the art, including embodiments which do not provide all of the features and advantages set forth herein, are also within the scope of this disclosure. Accordingly, the scope of the present disclosure is intended to be defined only by reference to the appended claims.

What is claimed is:

1. A method for managing reselection, comprising:
determining that a first subscription and a second subscription are in an idle state;
determining whether a signal quality (S_{qual}) of a serving cell on the first subscription exceeds a threshold; and
in response to determining that the signal quality (S_{qual}) of the serving cell on the first subscription does not exceed the threshold, reselecting to a neighbor cell on the first subscription and on the second subscription.

2. The method of claim 1, wherein the serving cell and the neighbor cell are associated with a same public land mobile network (PLMN).

3. The method of claim 1, wherein reselecting to a neighbor cell on the first subscription and the second subscription comprises:
identifying on the first subscription a neighbor cell satisfying one or more reselection criteria;
initiating a reselection timer on the first subscription to reselect to the neighbor cell;
identifying on the second subscription the same neighbor cell satisfying the one or more reselection criteria;
initiating a reselection timer on the second subscription to reselect to the neighbor cell.

4. The method of claim 3, further comprising:
determining whether the reselection timer on the first subscription is expired; and
in response to determining that the reselection timer on the first subscription is expired, determining whether the neighbor cell continues to satisfy the one or more reselection criteria.

5. The method of claim 4, further comprising:
in response to determining that the neighbor cell continues to satisfy the one or more reselection criteria:
receiving system information (SI) from the neighbor cell on the first subscription;
reselecting to the neighbor cell on the first subscription based at least in part on the SI associated with the neighbor cell; and
reselecting to the same neighbor cell on the second subscription.

6. The method of claim 5, wherein reselecting to the same neighbor cell on the second subscription includes reselecting to the same neighbor cell based at least in part on the SI associated with the neighbor cell received on the first subscription.

7. The method of claim 5, further comprising disregarding the reselection timer on the second subscription.

8. A method for handling mobility events, comprising:
determining that a first subscription is in an idle state and a second subscription is in a connected state;
determining whether a handover from a serving cell to a neighbor cell was successfully performed on the second subscription; and
in response to determining that the handover from the serving cell to the neighbor cell was successfully performed on the second subscription:
initiating a reselection on the first subscription; and
reselecting to the same neighbor cell on the first subscription.

9. The method of claim 8, wherein the serving cell and the neighbor cell are associated with a same public land mobile network (PLMN).

10. The method of claim 8, further comprising:
in response to determining that the handover from the serving cell to the neighbor cell is not successfully performed on the second subscription, determining whether an intra-frequency reselection from the serving cell to the neighbor cell was successfully performed on the first subscription; and
in response to determining that the intra-frequency reselection from the serving cell to the neighbor cell was successfully performed on the first subscription, triggering a mobility event on the second subscription.

11. The method of claim 10, wherein triggering a mobility event on the second subscription comprises:
determining a status of a handover time-to-trigger (TTT) on the second subscription to an intra-frequency neighbor cell; and
in response to determining that the handover TTT to the intra-frequency neighbor cell is initiated on the second subscription:
disregarding the handover TTT on the second subscription; and
performing a handover on the second subscription to the intra-frequency neighbor cell.

12. The method of claim 11, further comprising:
in response to determining that the handover TTT to the intra-frequency neighbor cell is not initiated on the second subscription, determining whether the intra-frequency neighbor cell is in a monitor set of the second subscription; and
in response to determining that the intra-frequency neighbor cell is in the monitor set of the second subscription, reporting on the second subscription a signal quality (S_{qual}) the intra-frequency neighbor cell to a public land mobile network (PLMN) of the serving cell.

13. The method of claim 12, further comprising receiving from the PLMN of the serving cell a request to add the intra-frequency neighbor cell to an active set of the second subscription.

14. The method of claim 12, further comprising:
in response to determining that the intra-frequency neighbor cell is not in the monitor set of the second subscription, adding the intra-frequency neighbor cell to the monitor set of the second subscription.

15. The method of claim 10, further comprising:
in response to determining that the intra-frequency reselection from the serving cell to the neighbor cell was not successfully performed on the first subscription, determining whether an inter-frequency or an inter radio access technology (RAT) reselection from the serving cell to the neighbor cell was successfully performed on the first subscription; and
in response to determining that the inter-frequency or inter-RAT reselection to the serving cell to the neighbor cell was successfully performed on the first subscription, transmitting a request to a public land mobile network (PLMN) of the serving cell for compressed mode (CM) to perform measurements of at least one inter-frequency or inter-RAT neighbor cell on the second subscription.

16. A mobile communication device, comprising:
a radio frequency (RF) chain; and
a control unit configured to:
determine that a first subscription and a second subscription are in an idle state;
determine whether a signal quality (S_{qual}) of a serving cell on the first subscription exceeds a threshold; and
in response to determining that the signal quality (S_{qual}) of the serving cell on the first subscription does not exceed the threshold, reselect to a neighbor cell on the first subscription and on the second subscription.

17. The mobile communication device of claim 16, wherein the serving cell and the neighbor cell are associated with a same public land mobile network (PLMN).

18. The mobile communication device of claim 16, wherein to reselect to a neighbor cell on the first subscription and the second subscription, the control unit is configured to:
identify on the first subscription a neighbor cell satisfying one or more reselection criteria;
initiate a reselection timer on the first subscription to reselect to the neighbor cell;
identify on the second subscription the same neighbor cell satisfying the one or more reselection criteria;
initiate a reselection timer on the second subscription to reselect to the neighbor cell.

19. The mobile communication device of claim 18, wherein the control unit is further configured to:
determine whether the reselection timer on the first subscription is expired; and
in response to determining that the reselection timer on the first subscription is expired, determine whether the neighbor cell continues to satisfy the one or more reselection criteria.

20. The mobile communication device of claim 19, wherein the control unit is further configured to:
in response to determining that the neighbor cell continues to satisfy the one or more reselection criteria:
receive system information (SI) from the neighbor cell on the first subscription;
reselect to the neighbor cell on the first subscription based at least in part on the SI associated with the neighbor cell; and
reselect to the same neighbor cell on the second subscription.

21. The mobile communication device of claim 20, wherein to reselect to the same neighbor cell on the second subscription, the control unit is configured reselect to the same neighbor cell based at least in part on the SI associated with the neighbor cell received on the first subscription.

22. The mobile communication device of claim 20, wherein the control unit is further configured to disregard the reselection timer on the second subscription.

23. A mobile communication device, comprising:
a radio frequency (RF) chain; and
a control unit configured to:
determine that a first subscription is in an idle state and a second subscription is in a connected state;
determine whether a handover from a serving cell to a neighbor cell was successfully performed on the second subscription; and
in response to determining that the handover from the serving cell to the neighbor cell was successfully performed on the second subscription:
initiate a reselection on the first subscription; and
reselect to the same neighbor cell on the first subscription.

24. The mobile communication device of claim 23, wherein the serving cell and the neighbor cell are associated with a same public land mobile network (PLMN).

25. The mobile communication device of claim 23, wherein the control unit is configured to:
in response to determining that the handover to from the serving cell to the neighbor cell is not successfully performed on the second subscription, determine whether an intra-frequency reselection from the serving cell to the neighbor cell was successfully performed on the first subscription; and
in response to determining that the intra-frequency reselection from the serving cell to the neighbor cell was successfully performed on the first subscription, trigger a mobility event on the second subscription.

26. The mobile communication device of claim 25, wherein to trigger a mobility event on the second subscription, the control unit is configured to:
determine a status of a handover time-to-trigger (TTT) on the second subscription to an intra-frequency neighbor cell; and
in response to determining that the handover TTT to the intra-frequency neighbor cell is initiated on the second subscription:
disregard the handover TTT on the second subscription; and
perform a handover on the second subscription to the intra-frequency neighbor cell.

27. The mobile communication device of claim 26, wherein the control unit is configured to:
in response to determining that the handover TTT to the intra-frequency neighbor cell is not initiated on the second subscription, determine whether the intra-frequency neighbor cell is in a monitor set of the second subscription; and
in response to determining that the intra-frequency neighbor cell is in the monitor set of the second subscription, report on the second subscription a signal quality (S_{qual}) of the intra-frequency neighbor cell to a public land mobile network (PLMN) of the serving cell.

28. The mobile communication device of claim 27, wherein the control unit is further configured to receive from the PLMN of the serving cell a request to add the intra-frequency neighbor cell to an active set of the second subscription.

29. The mobile communication device of claim 27, further comprising:
in response to determining that the intra-frequency neighbor cell is not in the monitor set of the second subscription, add the intra-frequency neighbor cell to the monitor set of the second subscription.

30. The mobile communication device of claim 25, wherein the control unit is configured to:
in response to determining that the intra-frequency reselection from the serving cell to the neighbor cell was not successfully performed on the first subscription, determine whether an inter-frequency or an inter radio access technology (RAT) reselection from the serving cell to the neighbor cell was successfully performed on the first subscription; and
in response to determining that the inter-frequency or inter-RAT reselection to from the serving cell to the neighbor cell was successfully performed on the first subscription, transmitting a request to a public land mobile network (PLMN) of the serving cell for compressed mode (CM) to perform measurements of at least one inter-frequency or inter-RAT neighbor cell on the second subscription.
